(19) United States
(12) Patent Application Publication
(10) Pub. No.: US 2011/0132533 A1
(43) Pub. Date: Jun. 9, 2011

(54) FORM-LINER HAVING IMPROVED IDENTIFICATION CAPABILITY

(76) Inventor: Martin Kögl, Munich (DE)

(21) Appl. No.: 13/057,479

(22) PCT Filed: Aug. 6, 2009
(86) PCT No.: PCT/DE2009/001099

§ 371 Date: Feb. 4, 2011

(30) Foreign Application Priority Data
Aug. 6, 2008 (DE) 10 2008 036 585.8
Aug. 6, 2009 (DE) 10 2009 036 310.6

(51) Int. Cl. B32B 37/14; B41B 11/54

(52) U.S. Cl. 156/272.2; 249/112

(57) ABSTRACT

The invention relates to a form-liner, especially for producing concrete and reinforced concrete structures, comprising a panel-shaped core and a lining skin having integrated identification elements. The invention further relates to a method for producing such form-liners.

### BACKGROUND OF THE INVENTION

1. Field of the Invention

The present invention concerns a formwork sheet, in particular for the production of concrete- and reinforced structure, which comprise a plate-shaped core and a formwork skin with identification elements. In addition the invention concerns a method for manufacturing such formwork sheets.

2. Description of the State of the Art

Formwork elements of the kind specified above provide a wide spectrum of different applications in the construction industry, which can vary from the conventional house building over civil engineering to special underwater buildings. The formwork elements are exposed to distinctive mechanical, chemical and environmental influences such as wind, water, ice, heat etc., which sets high demands on the used materials.

By the variety of different formwork elements required by a complex building project, the planning and accurate controlling of the required elements gains an enormous importance. Especially in the planning phase of the building projects, an exact determination of material requirement of the used formwork elements is an essential part of the complete building design. Beyond that, some formwork elements will be used a couple of times in various building phases, in order to delimit the costs for materials. Therefore, in the area of logistics and building design, a clear identification of a specific system component is of crucial importance, since significant problems can occur due to wrong deliveries or incorrect installation of the different formwork elements, which can affect time- and cost planning unfavorably.

Many companies are anxious about obtaining precise knowledge in a very early stage of the building design phase about which structural elements at which time at which place has to be built in, in order to be able to react accordingly, already at the delivery of the formwork element. Moreover it is of advantage regarding the partially available stockyard on construction sites, to already incorporate at the storage of the formwork elements, the later use in the construction phases into the stock management planning.

Also, a key aspect in combination with the identification of formwork elements represents the theft protection. Here the problem of deliberate destruction of distinguishing features have an effect, which makes it extremely difficult for companies to claim property rights, during insolvency proceedings for example.

A frequently occurring problem is additionally that in many building projects inventory formwork elements as well as rented formwork elements are often used together. Many enterprises have a basic assortment of formwork elements and rent or lease appropriate elements in addition for special requirement. The explicit identification of the inventory elements as well as the rented elements, at an inventory for example, it therefore also becomes a great importance.

In order to meet the requirements of the construction industry, the state of the art provide different possibilities, which makes a distinct identification possible.

The DE 100 55 060 A1 shows a specific holder for mounting a transponder within a through hole of a formwork panel which is to be considered as a weakening of the formwork element structure. Furthermore, such a holder can be manually easy removed, thus offers hardly the required identification security and is fragile and cost intensive due to its complex structure.

The DE 200 05 975 U1 shows as well a formwork panel, formwork beams and columns which should enable identification due to external attachment of transponder. Hence, it should be considered as prejudicial that the transponder can be also manually removed and completely unusable in its functionality by inappropriate use, or deliberate destruction. The very restricted readability of the transponder by the shielding effect of the metal is also to be considered as negative, because a high readability secureness can not be or hardly obtained. The here described transponder has to be connected with the formwork element during cost intensive processes which represents a big disadvantage.

High demands regarding the static stress are made to a formwork element and beyond that, the formwork panel should be also good nailable and screwable in order to be able to fasten for example different support parts such as block outs for doors or windows to the formwork panel.

The formwork panels described in EP 1,426,525 A1 shows a panel shaped core, a front and rear side as well as a layer from wood-flour-filled polypropylene (HMPP), which are printed, or is provided with a printed laminate layer, in particular with a printed on polyolefin film. These can be provided with information concerning manufacturers, manufacturing date, etc. or other references, as well as be printed with a special design, which increases the recognition value.

The EP 1,273,738 A2 also describes a formwork element that exhibits a panel shaped carrier, which is covered with a foil on at least one side. This can be printed or pasted likewise and thus an identification of such formwork elements is made possible.

Also here the components can be printed variously, pasted, to seal with leads, labeled, etc. so that a visible identification is possible. In order to fulfill the high mechanical, chemical or weather-related requirements of such identification means, also signs of most diverse materials are fasten onto, e.g. riveted, pasted, screwed, etc.

### SUMMARY OF THE INVENTION

The task of the present invention is it therefore, considering the above specified requirements and disadvantages, to create formwork sheets and formwork beams, which improves their identification ability in a simple and economical way.

### SOLUTION TO THE TASK

This task is solved according to the invention with a formwork element according to the independent claims. The dependent claims refer to favorable modifications as well as favorable embodiments of the invention.

The present invention is based on the idea, to improve the identification of formwork sheets by the fact that the therefore required identification elements are made in such manner that the possibility of a deliberate, or by a everyday work caused removing, or damaging of that identification elements, is reduced to a minimum.

Furthermore, it is thereby favorable that visual non-detectability of the identification elements can prevent intentional removing. Thereby, the characteristics of the formwork sheets regarding modularity, durability, maintenance and the required performance data should accommodate in a sufficient way.

Further advantages arise from the high level of prefabrication of the formwork skin according to the invention, as well as from the high redundancy of identification units which additionally leads to a low reading error rate. Advantages result likewise from the storage of relevant data on the identification elements, because therefore, costs in the IT for complex data base inquiries or data merging costs in distributed IT-systems can be reduced.

For this, according to the invention, it is intended that by minimum invasive changes in the production flows of the manufacturing of formwork sheets or formwork beams, identification elements are implemented in such way into formwork sheets and beams, so that a clear identification of the formwork elements is facilitated.

In order to provide the formwork sheet, which are used for producing concrete and reinforced concrete structures, with the necessary ability to solve the problem as described, a first layer will be formed as a plate-shaped core. This base plate provides a front and a back surface, whereby at least a second layer on at least one surface of the plate-shaped core is affixed to. At least one identification element is affixed onto or into this second layer.

Preferably, the second layer is formed as a foil in order to ease the handling within the production process and to configure the process steps more efficiently. It is preferred that the second layer is formed as a flexible foil.

Particularly preferably here is that at least one identification element is imprinted on the flexible foil. As a further advantage has been shown that the identification element provides an electronic based on conductive, semiconductive and/or non-conductive polymers. These identification elements are therefore based on polymer electronics or as well as on organic electronics. For this purpose it turned out to be preferable that the electronics of the identification elements consist of at least one antenna and an electronic circuit with a storage unit. Thus electronic circuits on the basis of organic or inorganic field effect transistors are preferably realized.

A roll-to-roll printing process which applies the identification element onto the foil is to be considered as particularly preferable. Thus by the usage of the roll-to-roll printing process, a continuous printing method is possible which leads to very low-priced electronic components because of the high throughput and high volumes. Based on the cost-effective printing process, contactless write- and/or readable identification elements have turned out to be preferable components of this production process.

Based on the broadly defined requirements profile for formwork sheets, the contactless write- and/or readable identification elements subsequently also called transponder, transceiver or tag plays a crucial role. Not only that this identification element must defy the environmental conditions in every day life on a construction site, it must be furthermore designed in such way that it survives unscathed the arising influences during the production process of the formwork sheet.

The electronic areas, for example an analog circuit for sending and receiving, a digital circuit, a permanent memory, a possibly existing energy storage, as well as an antenna should be protected against external mechanical, thermal or also chemical influences and to ensure an error-free operation of the identification elements in all application areas.

Regarding the types of use or also areas of application of the tags, two different data transmission technologies are preferable, which differ in principle by the different data signal transmission techniques. Here on the one hand the so-called “backscatter”-procedure is use, which reflects a radio signal sent by a reading device, or modulate information onto the respective signal, respectively field by field-weakening in the contact-free short-circuit. The communication unit for this used is also called transponder. On the other hand a communication unit is used, which is also designated as a transceiver, whereby their data transmission based on a signal sent by the transceiver.

The various tags can also be differentiated by their internal power supply elements within the tags. As a further particularly preferred embodiment, at least one contactless write- and/or readable electronic identification element can be based on a passive radio data transmission technology, which does not need to have an internal power supply. The advantage here is that the passive tags generate their energy for the supply of the microchip from the received radio waves.

Furthermore it can be provided for example that at least one contactless write- and/or readable electronic identification element can be based on an active, or also a semi-active radio data transmission technology, which can provide an internal power supply. These generic tags can be equipped with batteries, which are responsible for the power supply of the microchip, but also used for the energy transmission of transceivers and which can be able to facilitate a significantly higher range for the writing and/or reading of the tag data, than passive tags.

In this respect, it is also a preferred objective according to the invention that the tag can be based on a radio transmission technology, which can work at low frequencies between 30 Hz to 1 MHz. Here it is particularly preferred that the frequency can be in the range from 120 kHz to 133 kHz. Especially preferred in this frequency range is the frequency 125 kHz or 131 kHz and that the electromagnetic energy field which is needed for writing and reading of the tag-data, provides a magnetic portion of at least 60%.

A further objective of the invention is that the tag can be based on a technology, which can work at high frequencies within the range of 3 MHz to 30 MHz. In the range of the high frequencies here a frequency at 4.91 MHz or 13.56 MHz is favorable. In this case, it is particularly preferred in the sense of the invention that the electromagnetic energy field can provide a magnetic portion of not more than 45%. A further objective of the invention is that the tag can be based on a technology, which can work at high frequencies within the range of 3 MHz to 30 MHz. In the range of the high frequencies here a frequency at 4.91 MHz or 13.56 MHz is favorable. In this case, it is particular preferred in the sense of the invention that the electromagnetic energy field can provide a magnetic portion of not more than 45%. Regarding a further objective of the invention, the use of a radio data communication technology is preferred, which can work within a range with very high frequencies from 400 MHz to 6 GHz. The frequencies 433 MHz, 868 MHz, 915 MHz, 950 MHz, 2.45 GHz, or 5.8 GHz have been proved as particularly preferred frequencies. Further it is particularly preferred that the energy field at frequencies in the range from 400 MHz to 6 GHz can provide a magnetic portion of not more than 20%.

Furthermore, communication bandwidth from 300 to 9600 baud are favorable, particularly preferred can be 1200 baud. In view of a radio data communication technology which works with high, or very high frequencies, reading processes in the range of 150 to 200 reading processes per second can be particularly preferred, whereas at low frequencies below 3 MHz the amount of reading processes in the range from 5 to 20 reading processes per second are particularly preferred.

Further, the invention provides a procedure for manufacturing of a formwork sheet. The procedures according to the invention facilitates an economical production of an innovative formwork element of different design that can provide significantly improved identification capabilities and which additionally has the advantage that only small changes in the industrial process has to be made and a subsequent adaptation of existing formwork elements is also facilitated. In this connection, only a few additional process steps are necessary due to the high level of prefabrication of the identification elements. At the same time, the formwork element still provides a simple construction so that a well-known and generic formwork sheet can be modified in the view of the invention. Here the formwork sheet can be formed as a part of a formwork beam.

Since the improvements of the state of the art according to the invention can be realized with simple, economical devices and procedures, surprising advantages arise regarding costs, efficiency and sustainability, because the embodiments according to the invention also facilitates subsequent modifications of already produced formwork elements. Thus a complete and constant identification- and logistics chain of formwork elements already circulated up to newly produced formwork elements, as well as their components can be ensured.

Further details of the invention result from the following detailed description and the attached schematic figures, in which preferred embodiments of the formwork element according to the invention are described in detail. However, these embodiments are not meant to limit the invention in any way and have an exemplary character. The above mentioned features can be combined in any way, partly or as a whole.

### BRIEF DESCRIPTION OF THE FIGURES

FIG. 1 shows a sectional view of a formwork sheet of the first embodiment;

FIG. 2 shows a sectional view of a formwork sheet of the second embodiment;

FIG. 3 shows a perspective explosion view of the first embodiment;

FIG. 4 shows a perspective explosion view of the second embodiment;

FIG. 5 shows process steps for the manufacturing of the formwork sheets according to the invention;

FIG. 6 shows a side view of a formwork beam with a solid wall bar of the third embodiment;

FIG. 7 shows a side view of a formwork beam with a framework bar of the third embodiment;

FIG. 8 shows a sectional view of a third embodiment of the formwork beam showed in FIG. 6 along the line A-A′;

FIG. 9 shows a further sectional view of a third embodiment of the formwork beam showed in FIG. 6 along the line A-A′;

### DESCRIPTION OF THE PREFERRED EMBODIMENTS

Preferable embodiments of the formwork sheet according to the invention are described in the following in detail with reference to the accompanying figures.

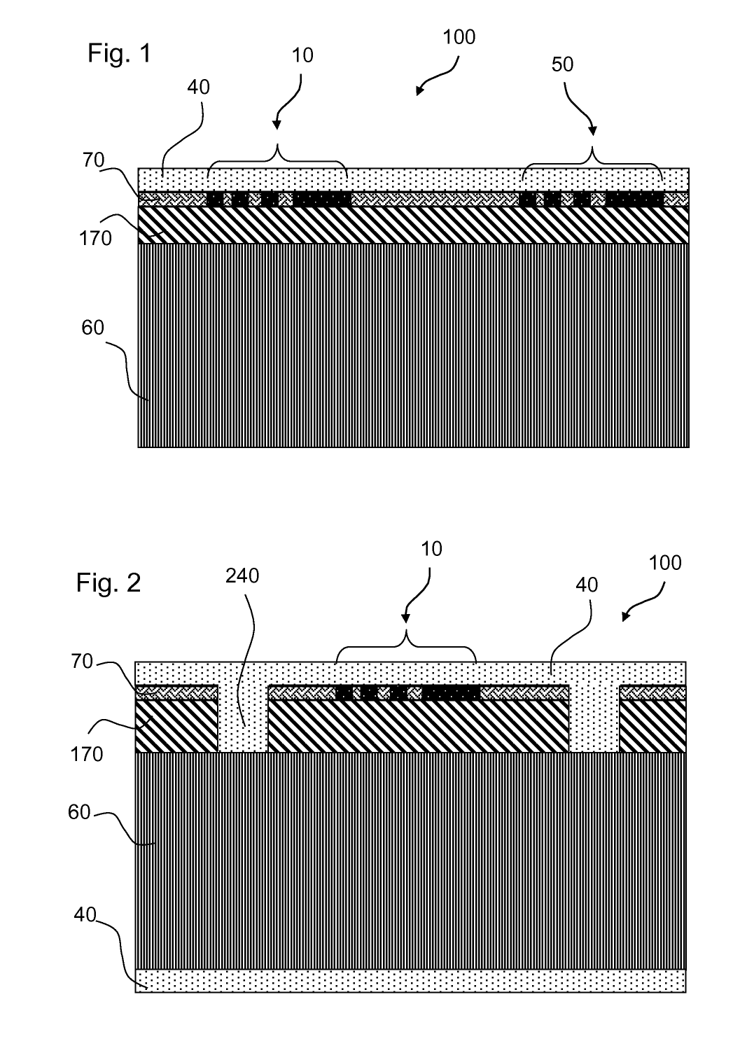

The formwork sheet 100 as shown in FIG. 1 consists of a first layer, for example a plate-shaped core 60 which is covered with a second layer, respectively a coating, or a foil 170. The foil 170 serves in this regard as a basis layer for the identification elements 10, 50 and can provide non-conductive characteristics. The identification elements 10, 50 are imprinted onto the foil by a printing process and it is therefore adhesively joined. In order to even the so generated spaces, a filler material 70 is applied onto the foil which is used for additional stability and protection against environmental influences.

Due to various printing methods such as the flexo printing-, offset printing-, gravure printing-, or rotary screen printing methods, the imprinted identification elements can form a force-locked connection with the respective base material 170. The hereto used materials are preferably soluble polymers, which can be used as electronic ink due to dissolvent during the printing processes.

As an additional protection layer, a further layer 40 can be applied, which is opaque or imprinted with company logos or other information. Furthermore, imprinted polymer structures are favorable, which can realize various sensors due to its specific configuration. Sensors like temperature-, elongation-, pressure-, or humidity-sensors for example can register the actual status of the formwork sheet and detect, store and transmit to respective reading devices any potential weak points or ageing processes.

The plate-shaped core can consist of various materials. Some materials are proved as particularly robust and resistant, which fulfill the high standards to the load capacity and the modulus of elasticity (measurement for the rigidity). Here, usually it concerns wood, respectively wood composite materials, which can be manufactured by pressing of different wood parts like panels, rods, veneer, veneer strips, splinters and fibres with adhesive or bonding agents. The different wood components can be arbitrarily arranged in their dimensions and strength, as well as regarding their position. Commercial panels are for example OSB chip boards, veneer plywood-, multiplex-, MDF-, HDF panels, in addition, multilayer solid wood panels. Also the use of other nature materials, like hemp or bamboo is conceivable in this connection.

Furthermore, the plate-shaped core 60 can be manufactured from a foamed, a honeycombed or a solid plastic panel. There are also different composite materials conceivable, as for example fiber composite material or metal, respectively metal-composite materials, which can provide a panel with sufficient characteristics regarding stiffness and rigidity.

The identification element 10 concerns a so-called transponder or transceiver, which is based on a passive radio data communication technology. Here it primarily concerns a so-called radio frequency identification technology (RFID). In a not shown embodiment, the RFID transponder mainly consists of a permanent memory, a digital circuit, an analog circuit for receiving and sending, one or more different antennas, an energy storage, as well as a carrier and a case. Beside the RFID technology, also different radio network standards, for example WiFi, ZigBee, Bluetooth or RuBee can be used.

In order to exclude intensively interference between the identification elements, the distance between the tags should not be less than the minimum of 50 mm. Furthermore, tags are favorable which are able to work on the basis of different frequencies. These tags are designed with two or more antennas, which enable them to receive and/or transmit data on different frequencies.

Into the identification element 10, a current is induced into the antenna by an alternating electromagnetic field, which is able to activate a microchip, so that it can receive commands from a reader and can modulate an answer into the electromagnetic field sent by the reader. This answer can contain data, which were stored in the appropriate memory.

A major advantage lies in the fact that these data regarding the formwork element according to the invention, can contain different information, like for example type designation, manufacturer and manufacturing date, weight, material as well as buyer, respectively borrower identification numbers etc. Additionally, information regarding the building project can be of importance, as for example information concerning the building site or the accurate location in a complex formwork system.

Regarding the stored data of the formwork elements according to the invention it is very favorable, to store and secure these data in networked, distributed systems. By a complex distributed data base- and system structure, data losses are avoided and world-wide accesses to the data are guaranteed, so that a constant and complete life cycle of a formwork element according to the invention can be illustrated. Thus at each time an exact, overall and automatic data alignment can be facilitated.

Because of the fact that the used passive transponders provide no internal power supply, they can be produced relatively cost-efficiently. Regarding the insertion into the formwork elements according to the invention, different design of the identification elements can be selected. As in FIG. 1 schematically shown, the identification element can have a height of several hundred micrometers up to several millimeters, as well as the surface area varies from some square millimeter up to some square centimeter. Furthermore, the used transponder can be made of materials which provide an insensitivity against mechanical or chemical influences particularly during the production process of the formwork element according to the invention.

Here also organic electronics can be used, which are favorable regarding the recycling. These organic circuits consist of conductive polymers or smaller organic compounds, whereby these electronic polymers consist of conjugated polymer main chains.

The use of more than one tag represents an enormous advantage, due to the higher number of tags, the required higher redundancy regarding the desired identification safety can be realized. The redundant tags are needed thereby, because during formworks, box-outs or shuttering parts are mounted onto the formwork element by screws or nails, which can perhaps make a tag useless. Therefore, the identification secureness increases with the amount of tags.

The transceiver 50 shown in FIG. 1 is based on a different radio data communication technology than the transponder 10. Here, it concerns a data signal sending transceiver 50, which is part of a data communication system with the name RuBee that uses a data protocol which enables the specific transceiver-tags to link them together by a bi-directional, on-demand, peer-to-peer network architecture. The system mainly consists of specific tags (transceiver 50) which works at a frequency below 1 MHz and provide an integrated circuit, a oscillating circuit (quartz), an internal power supply as for example a lithium-, respectively an alkaline battery and a data storage unit.

These identification elements can be additionally divided into active and semi-active tags 50 and have various prolonged operating times, whereby active elements provides only a shorter life time due to their permanent activity. However, semi-active tags are put into a sleep mode and send data only if they are activated by a wake-up signal which furthermore leads to longer life times. Therefore mainly semi-active tags are used, compared with the active ones, because operation times are calculated from five to twenty years.

The upper coating 40 has special characteristics regarding mechanical or chemical resistance in relation to effects from the outside. Because both the upper coating 40, as well as the bottom coating 40 could have direct contact with concrete, they should be easily cleaned. In order to additionally increase the scratch- and abrasion resistance as well as the general resistance, the coating could provide for example a nano-tube structure and to improve the cleanability of the coating, a nano-coating can be applied, which generates the so-called lotus effect artificially.

The foil 170 and/or the coating 40 could consist of polyester, polyethylene terephthalate, polypropylene, polyethylene, polyvinyl chloride or a phenolic resin coating, which are laminated, glued or rolled onto etc. during the manufacturing process.

In order to improve the connection between the foil 170 and the coating 40, as well with the plate-shaped core, recesses 240 in the foil 170 are provided which are refilled by the coating 40 during the manufacturing process. Thus, a materially joined connection is formed which can prevent the detachment of the coating.

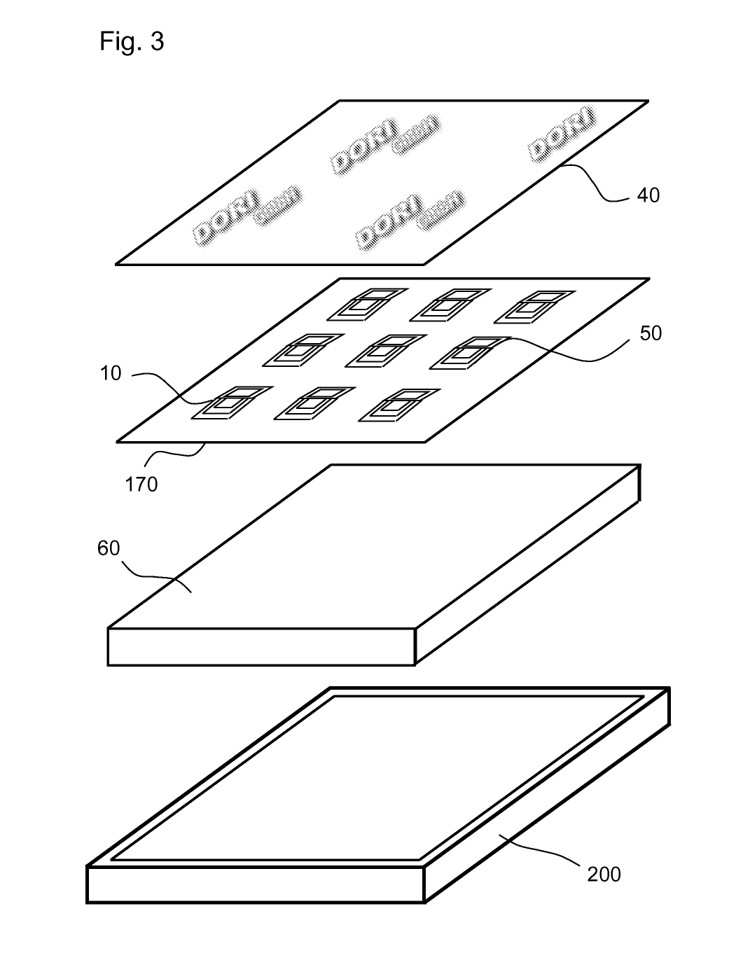

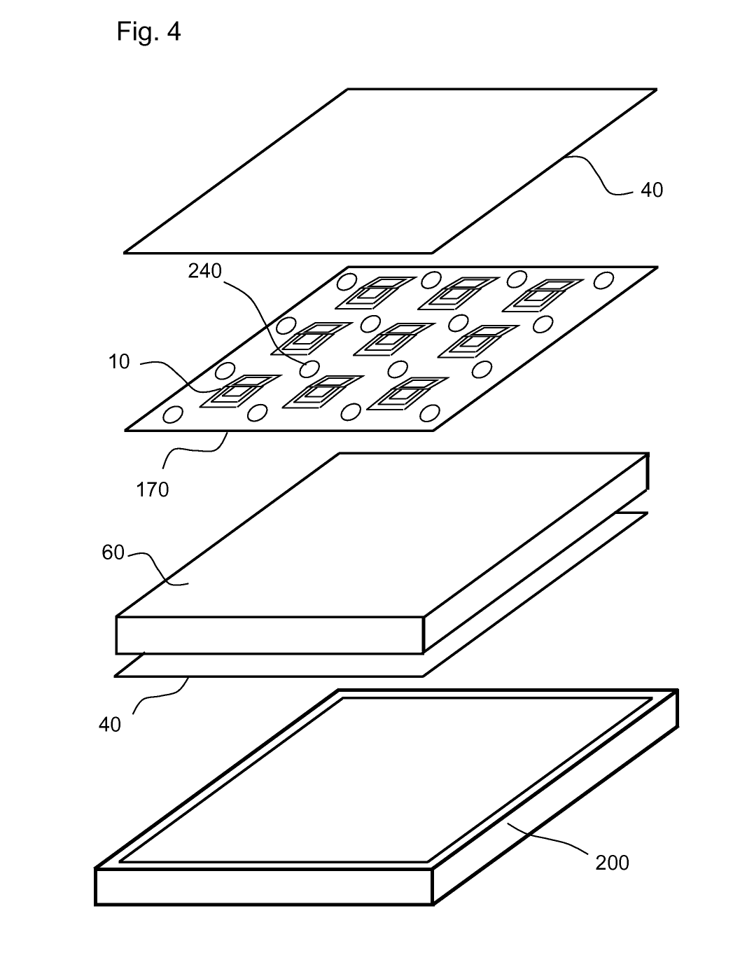

The FIGS. 3 and 4 are showing perspective explosion views of a framed formwork, which shows a frame element 200, in which the plate-shaped core 60 is positioned or fixed thereto. This core will be applied with the foil 170, onto which the identification elements 10 or 50 are imprinted.

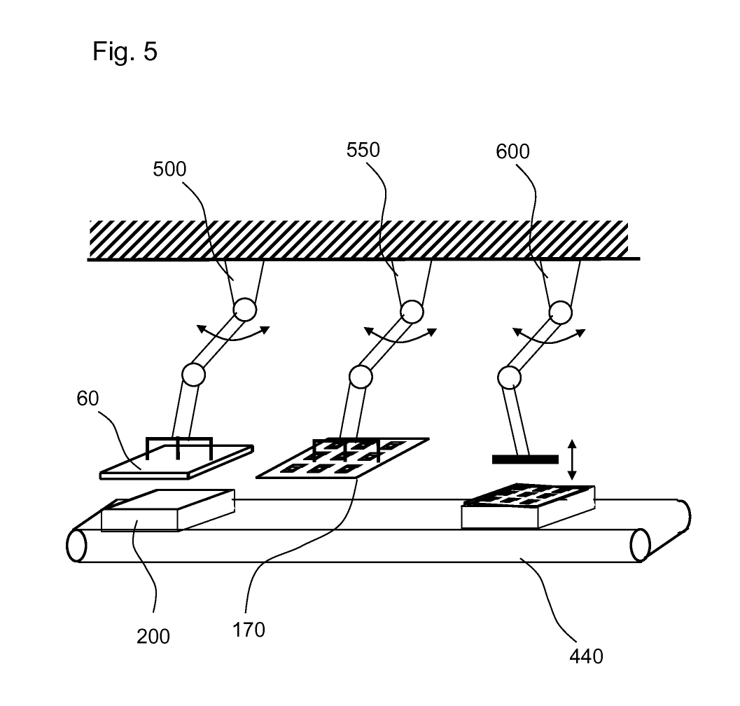

FIG. 5 shows a device which can perform the process steps for manufacturing the formwork sheet according to the invention. A component supply unit 500, to accommodate and position the previously provided plate-shaped core 60 onto a transport unit 440 which can be realized as a production line or as a conveyer system. An additional supply unit 550 applies the second layer, which can be realized as a foil in its largely planar extension, onto the plate-shaped core 60. Already prefabricated polymer electronic tags are imprinted onto the foil 170 and can be therefore directly applied onto the plate-shaped core.

The supply unit 600 applies a further layer, which can be realized as a protection layer or as a coating, or can imprint the surface by a specific process or by spraying the surface with color. A further task of the unit 600 can be, to form a force-joined- and/or a material joined connection between the first and the second layer.

An additional process step is favorable, in case of a respective frame element 200 provisioning, that can be realized as a formwork beam as shown in FIGS. 6 to 9. Here, the frame element 200 takes over the task of a top chord 410, respectively of a bottom chord 420. As shown in FIG. 5, the provision of a frame element, which is realized as a formwork beam is reasonable, because the usual process sequence as know from the state of the art, is only changed marginally. The process sequence as shown here is characterized by the fact that no or at least only a small change in the process is necessary due to the high level of prefabrication of the foil 170.

Therefore, an unexpected big cost advantage with regards to processing time, machine changing effort or production line changes is produced. The combination of extremely reasonable identification elements on the basis of polymeric electronic and the minimal-invasive changes in the production process of such formwork elements, leads to a decisive industrial competitive advantage.

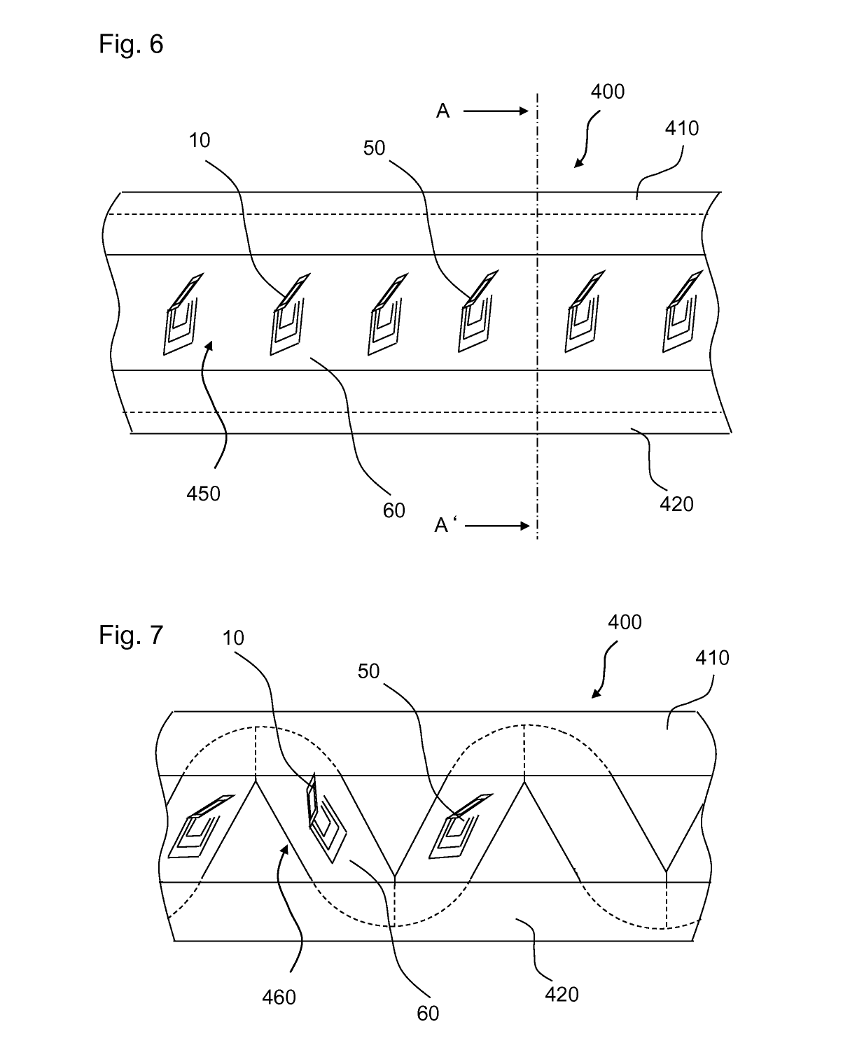

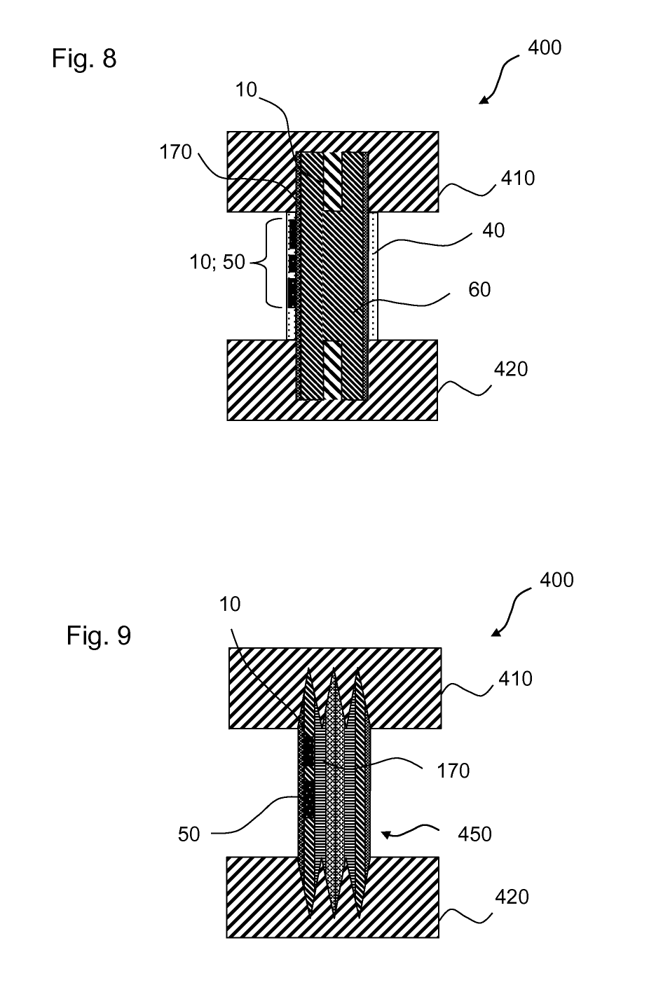

The FIGS. 6 and 7 show a formwork sheet 60 according to the invention which can be realized as a solid wall bar 450 or as a framework bar 460. Furthermore, the formwork sheet 60 is covered on its top- and bottom site by a top chord 410 and a bottom chord 420. Hence FIGS. 8 and 9 are showing sectional views of the formwork beam according to the invention, which use a formwork sheet 60 as a basic bar object which also provide a foil 170 with integrated identification elements 10, 50.

1-33. (canceled)

34. Formwork sheet for producing concrete and reinforced concrete structures comprising
a first layer, which is formed as a plate-shaped core and has a front and a back surface, and
at least a second layer, which is affixed to at least one of the surfaces of the plate-shaped core, wherein
at least one electronic identification element is affixed onto this second layer.

35. A formwork sheet according to claim 34, wherein the second layer is formed as a flexible foil.

36. A formwork sheet according to claim 35, wherein the at least one electronic identification element is imprinted onto the flexible foil.

37. A formwork sheet according to claim 34, wherein the electronic identification element includes conductive, semi-conductive or non conductive polymers.

38. A formwork sheet according to claim 34, wherein the electronic identification element includes at least one antenna and an electronic circuit with a storage unit.

39. A formwork sheet according to claim 38, wherein the electronic circuit includes organic or inorganic field effect transistors.

40. A formwork sheet according to claim 36, wherein the electronic identification element is applied onto the foil by a roll-to-roll printing process.

41. A formwork sheet according to claim 34, wherein the electronic identification element is a transponder and is contactlessly writeable and/or readable.

42. A formwork sheet according to claim 41, wherein the contactlessly writeable and/or readable electronic identification element is a transponder and uses a radio data communication technology with frequencies in the range between 3 MHz and 6 GHz.

43. A formwork sheet according to claim 41, wherein the contactlessly writeable and/or readable electronic identification element is a transponder and uses a radio data communication technology with frequencies in the range between 3 MHz and 6 GHz, and wherein the magnetic portion of the used energy field is less than 45%.

44. A formwork sheet according to claim 34, wherein the electronic identification element is a transceiver and is contactlessly writeable and/or readable.

45. A formwork sheet according to claim 44, wherein the contactlessly writeable and/or readable electronic identification element is a transceiver and uses a radio data communication technology with frequencies in the range between 30 Hz and 1 MHz.

46. A formwork sheet according to claim 44, wherein the contactlessly writeable and/or readable electronic identification element is a transceiver and uses a radio data communication technology with frequencies in the range between 30 Hz and 1 MHz, and wherein the magnetic portion of the used energy field is at least 60%.

47. Formwork sheet for producing concrete and reinforced concrete structures, wherein the formwork sheet is formed as a bar, comprising
a first layer, which is formed as a plate-shaped core and has a front and a back surface, and
at least a second layer, which is affixed to at least one of the surfaces of the plate-shaped core, wherein
at least one electronic identification element is affixed onto this second layer.

48. A formwork sheet according to claim 47, wherein the formwork sheet is formed as bar and is surrounded by a top- and/or bottom chord.

49. A formwork sheet according to claim 47, wherein the second layer is formed as a flexible foil.

50. A formwork sheet according to claim 49, wherein the at least one electronic identification element is imprinted onto the flexible foil.

51. A formwork sheet according to claim 47, wherein the electronic identification element includes conductive, semi-conductive or non-conductive polymers.

52. A formwork sheet according to claim 47, wherein the electronic identification element includes at least one antenna and an electronic circuit with a storage unit.

53. A formwork sheet according to claim 52, wherein the electronic circuit includes organic or inorganic field effect transistors.

54. A formwork sheet according to claim 53, wherein the electronic identification element is applied onto the foil by a roll-to-roll printing process.

55. A formwork sheet according to claim 47, wherein the electronic identification element is a transponder and is contactlessly writeable and/or readable.

56. A formwork sheet according to claim 55, wherein the contactlessly writeable and/or readable electronic identification element is a transponder and uses a radio data communication technology with frequencies in the range between 3 MHz and 6 GHz.

57. A formwork sheet according to claim 55, wherein the contactlessly writeable and/or readable electronic identification element is a transponder and uses a radio data communication technology with frequencies in the range between 3 MHz and 6 GHz, and wherein the magnetic portion of the used energy field is less than 45%.

58. A formwork sheet according to claim 47, wherein the electronic identification element is a transceiver and is contactlessly writeable and/or readable.

59. A formwork sheet according to claim 58, wherein the contactlessly writeable and/or readable electronic identification element is a transceiver, and uses a radio data communication technology with frequencies in the range between 30 Hz and 1 MHz.

60. A formwork sheet according to claim 58, wherein the contactlessly writeable and/or readable electronic identification element is a transceiver and uses a radio data communication technology with frequencies in the range between 30 Hz and 1 MHz, and wherein the magnetic portion of the used energy field is at least 60%.

61. A method for producing a formwork sheet, wherein the procedure comprises:
providing a first layer, which is formed as a plate-shaped core;
providing a second layer, with pre-imprinted identification elements;
assembling both sheet layers; and
joining both sheet layers.

62. A method for producing a formwork sheet according to claim 61, wherein the second layer is formed as a foil.

63. A method for producing a formwork sheet according to claim 61, wherein the electronic identification element have data written to them.
